(19) United States
(12) Patent Application Publication
(10) Pub. No.: US 2022/0173825 A1
(43) Pub. Date: Jun. 2, 2022

(54) OPTICAL NETWORK ON CHIP FOR PROCESSOR COMMUNICATION

(71) Applicant: HEWLETT PACKARD ENTERPRISE DEVELOPMENT LP, Houston, TX (US)

(72) Inventors: LUCA RAMINI, Cernusco sul Naviglio (MIIan) (IT); Jinsung YOUN, Milpitas, CA (US); Steven DEAN, Chippewa Falls, WI (US); Marco FIORENTINO, Milpitas, CA (US)

(21) Appl. No.: 17/107,212

(22) Filed: Nov. 30, 2020

(51) Int. Cl. H04J 14/02; H04B 10/27

(52) U.S. Cl. CPC H04J 14/0278; H04B 10/27

(57) ABSTRACT

An optical network on chip comprises a first optical communication link and a second communication optical link. The first communication optical link comprises a plurality of first wavelength division multiplexers (WDMs) coupled to a first processor, a plurality of second WDMs coupled to a second processor, and a plurality of first optical interconnects coupled between the plurality of first WDMs and the plurality of second WDMs. The second optical communication link comprises a plurality of first serializer-deserializers (SerDes) coupled to the first processor at one end and coupled to a plurality third WDMs at the other end, a plurality of second SerDes coupled to a memory component at one end and coupled to a plurality of fourth WDMs at the other end, and a plurality of second optical interconnects coupled between the plurality of third WDMs and the plurality of fourth WDMs.

### DESCRIPTION OF RELATED ART

Processor architectures for use in high-performance computing systems generally comprise processors and memory components. The processors and the memory components are communicatively coupled to each other via electrical interconnects to perform various computational tasks associated with the high-performance computing systems.

### BRIEF DESCRIPTION OF THE DRAWINGS

The present disclosure, in accordance with one or more various embodiments, is described in detail with reference to the following figures. The figures are provided for purposes of illustration only and merely depict typical or exemplary embodiments.

FIG. 1 illustrates an example processor architecture in accordance with various embodiments of the present disclosure.

FIG. 2 illustrates an example first optical communication link in accordance with various embodiments of the present disclosure.

FIG. 3 illustrates an example second optical communication link in accordance with various embodiments of the present disclosure.

FIG. 4 illustrates a cross-sectional view of an example interposer in accordance with various embodiments of the present disclosure.

FIG. 5 illustrates an example printed circuit board of a high-speed computing system in accordance with various embodiments of the present disclosure.

FIG. 6 illustrates an example method, according to various embodiments of the present disclosure.

The figures are not exhaustive and do not limit the present disclosure to the precise form disclosed.

### DETAILED DESCRIPTION

Processor architectures, such as graphics processor unit (GPU) architectures, are rapidly evolving to accommodate today's explosive increase in data throughput of high-performance computing systems. Processor architectures for use in high-performance computing systems generally comprise processors and memory components disposed on an interposer of a printed circuit board associated with the high-performance computing systems. The processors and the memory components can be communicatively coupled to each other via electrical interconnects on the interposer. The electrical interconnects, generally, are copper-based interconnects. As data throughput requirements increase, data transmission between the processors, and between the processors and the memory components, through the electrical interconnects, correspondingly increase. One way to increase data transmission between the processors, and between the processors and the memory components is to increase frequencies of signals carried by the electrical interconnects. However, because the electrical interconnects are copper-based, the extent to which the data transmission can be increased is limited by the physics of having to carry high-frequency signals in copper-based interconnects. For example, signal integrity of a signal can significantly decrease as frequency of the signal increases. Furthermore, a high-frequency signal can cause various interferences, such as cross-talk, to neighboring signals during transmission. As such, as data throughput of high performance computing systems continues to increase, data transmission based on copper-based interconnects may become more and more challenging.

Described herein are solutions that address the problems described above. In various embodiments, the claimed invention can comprise an integrated silicon photonics (SiPh) interposer on which a plurality of processors and a plurality of memory components are disposed. The plurality of processors and the plurality of memory components can be communicatively coupled to each other via optical interconnects on the SiPh interposer, thereby forming an optical network-on-chip (ONoC). Because optical interconnects are used in lieu of electrical interconnects described above, the claimed inventions can support much higher data transmission with less signal integrity issues between the plurality of processors, and between the plurality of processors and the plurality of memory components than traditional approaches.

In some embodiments, optical interconnects disposed between any two processors of the plurality of processors can include a wavelength division multiplexer (WDM) at each end of the optical interconnects. The WDM is a transceiver device that can be configured either as a multiplexer or a demultiplexer. When a WDM is configured as a multiplexer, the WDM can convert and combine (i.e., multiplex or mux) multiple electrical signals outputted by a processor into a single optical signal, which carries multiple wavelengths, for data transmission. When a WDM is configured as a demultiplexer, the WDM can separate or decompose (i.e., demultiplex or demux) an optical signal into its constituent electrical signals. By utilizing WDMs for data transmission between the plurality of processors, a number of interconnects needed for data transmission can be reduced. This implementation thus can reduce routing complexity between the plurality of processors on the SiPh interposer and minimize any potential cross-talk issues that are prevalent in electrical interconnects.

In some embodiments, optical interconnects disposed between a processor of the plurality of processors and a memory component of the plurality of memory components can include a WDM coupled a plurality of serializer-deserializers (SerDes) at each end of the optical interconnects. Functionalities of a WDM have been discussed above. A SerDes is a transceiver that can be configured either as a serializer or a deserializer. When a SerDes is configured as a serializer, the SerDes can serialize (e.g., convert or combine) multiple parallel electrical signals associated with a processor or a memory component into a single serialized electrical signal. Multiple serialized electrical signals from multiple SerDes can then be multiplexed by a WDM for data transmission through an optical interconnect. When a SerDes is configured as a deserializer, the SerDes can deserialize (e.g., separate or decompose) a serialized electrical signal demultiplexed by a WDM, from a multiplexed optical signal, into its constituent parallel electrical signals. By utilizing SerDes in conjunction with WDMs for data transmission between the plurality of processors and the plurality of memory components, a number of interconnects needed for data transmission can be greatly reduced. This implementation thus can greatly reduce routing complexity between the plurality of processors and the plurality of memory components on the SiPh interposer and minimize any potential cross-talk issues that are prevalent in electrical interconnects.

In some embodiments, multiple SiPh interposers can be disposed on a printed circuit board (PCB) associated with a high-speed computing system. The multiple SiPh interposers can be communicatively coupled to one another via fiber optic on the PCB. Such an architecture allows the high-speed computing system to easily scale as computational demands increase. For example, to increase computational performance of a computing system, an existing PCB board with one SiPh interposer can be replaced with a PCB board with two SiPh interposers. In this example, the computation performance of the computing system is doubled. These and other features of the claimed invention will be discussed in further detail herein.

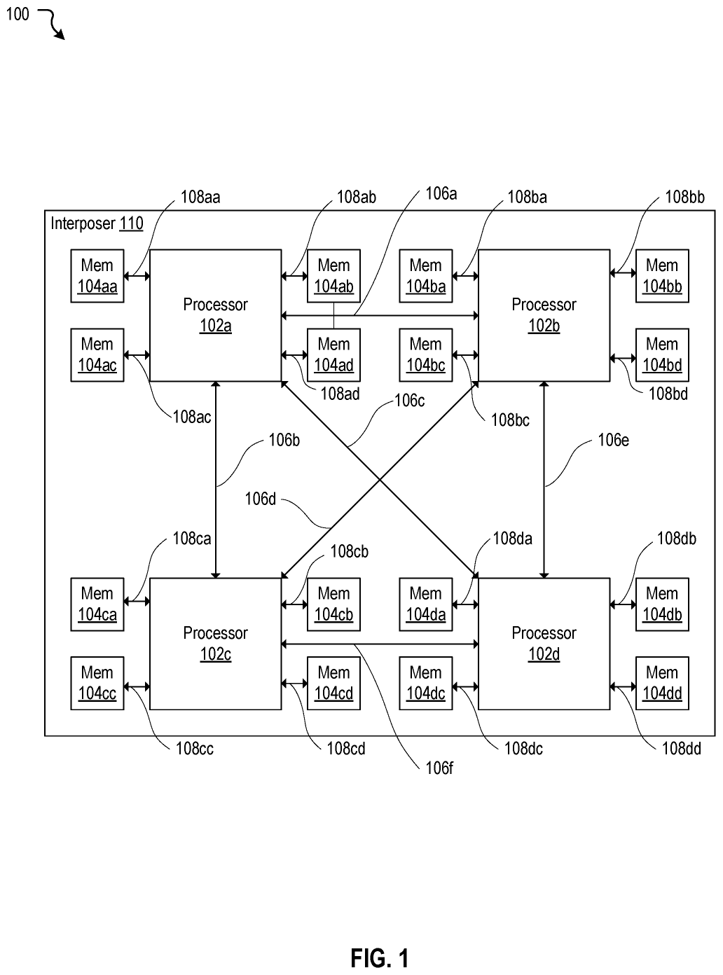

FIG. 1 illustrates an example processor architecture 100 in accordance with various embodiments of the present disclosure. As shown in FIG. 1, the processor architecture 100 can include an interposer 110. The interposer 110 can be a physical layer on a printed circuit board (PCB) of a high-speed computing system on which various processors, such as central processing units (CPUs) or graphics processing units (GPUs) and their associated memory components (e.g., high-bandwidth memory, electrically erasable programmable read-only memory, etc.) can be disposed and communicatively coupled. In some embodiments, the interposer 110 can comprise a plurality of processors 102a-102d and a plurality of memory components 104aa-104dd associated with the plurality of processors 102a-102d. For example, the memory components 104aa, 104ab, 104ac, and 104ad are associated with the processor 102a and the memory components 104ba, 104bb, 104bc, and 104bd are associated with the processor 102b, and so on. In general, each processor of the plurality of processors 102a-102d can perform various computational tasks associated with the high-speed computing system by executing data and/or instructions stored in its associated memory components. For example, the processor 102c may perform optimization of a data representation by accessing data and/or instructions stored in the memory components 104ca, 104cb, 104cc, and 104cd. As another example, the processor 102d may perform machine learning training by accessing data and/or instructions stored in the memory components 104da, 104db, 104dc, and 104dd.

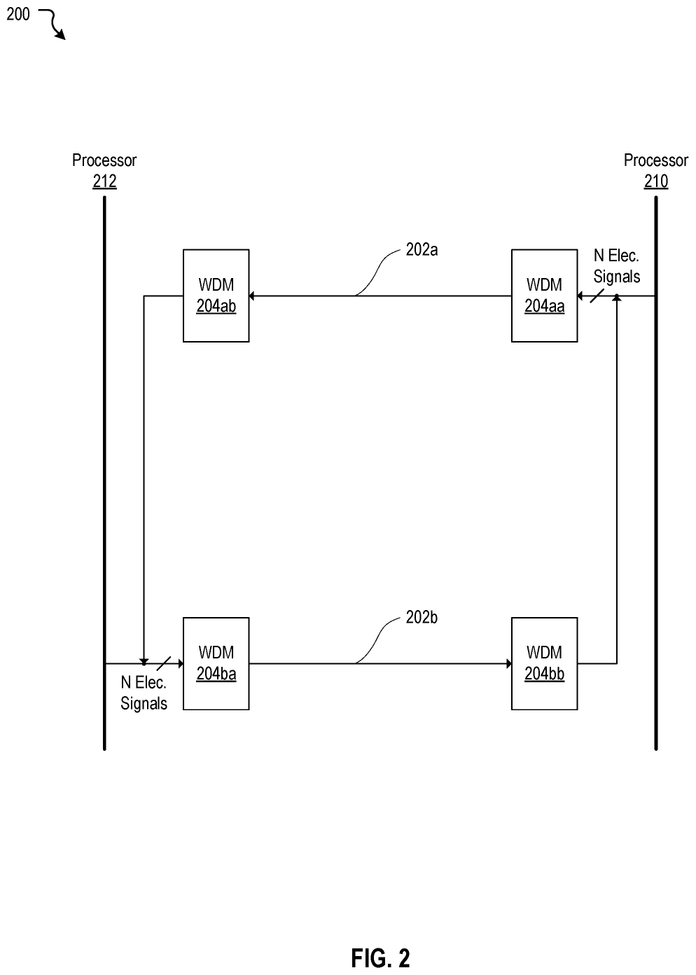

In some embodiments, the interposer 110 can include a plurality of first optical communication links 106a-106f disposed between the plurality of processors 102a-102d on the interposer 110. Through the plurality of first optical communication links 106a-106f, the plurality of processors 102a-102d may transmit data back and forth, share computational tasks, and/or otherwise communicate with each other. For example, as shown in FIG. 1, the processor 102a is coupled to the processor 102b via the first optical communication link 106a, coupled to the processor 102c via the first optical communication link 106b, and coupled to the processor 102d via the first optical communication link 106c. In this example, the processor 102a may communicate with the processors 102b-102d to share computational tasks through the first optical communication links 106a-106c, respectively. In some embodiments, each optical communication link of the plurality of first optical communication links 106a-106f can comprise a plurality of first optical interconnects. The plurality of first optical communication links 106a-106f and the plurality of first optical interconnects will be discussed in further detail with reference to FIG. 2 herein.

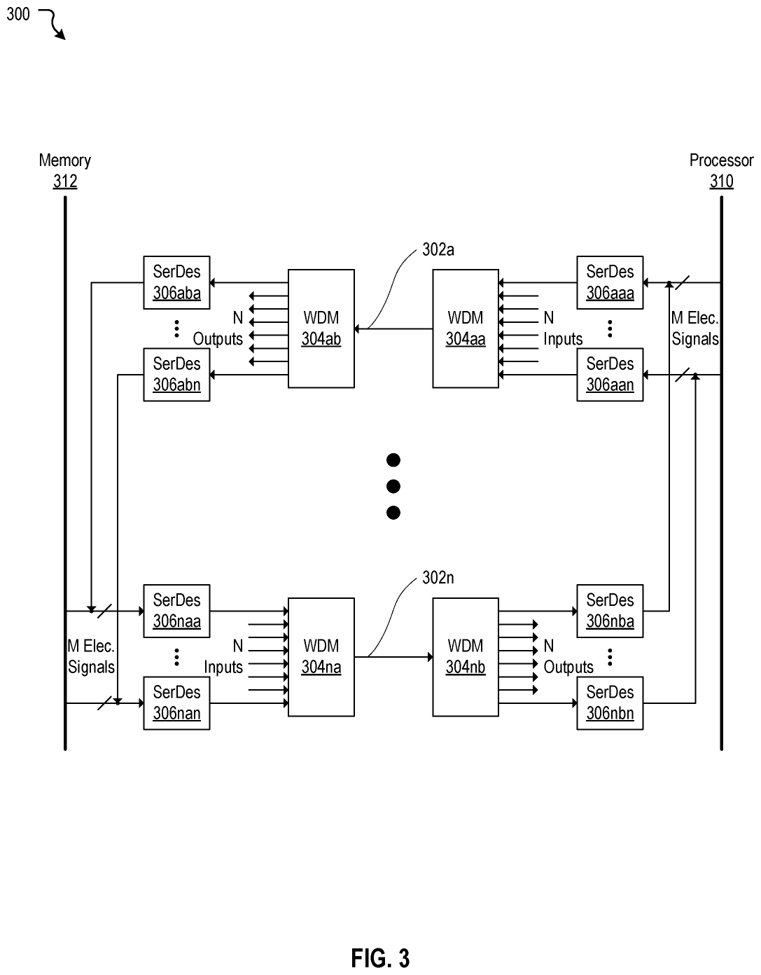

In some embodiments, the interposer 110 can include a plurality of second optical communication links 108aa-108dd disposed between each processor of the plurality of processors 102a-102d and its associated memory components. Through the plurality of second optical communication links 108aa-108dd, each processor of the plurality of processors 102a-102d can write data to and/or read data from its associated memory components. For example, as shown in FIG. 1, the processor 102a is coupled to the memory components 104aa-104ad via the second optical communication link 108aa-108ad, respectively. In this example, the processor 102a may write data to and/or read data from the memory components 104aa-104ad, through the second optical communication link 108aa-108ad as the processor 102a performs computational tasks. In some embodiments, each optical communication link of the plurality of second optical communication links 108aa-108dd can comprise a plurality of second optical interconnects. The plurality of second optical communication links 108aa-108dd and the plurality of second optical interconnects will be discussed in further detail with reference to FIG. 3 herein.

In general, the processor architecture 100 provides significant data transmission performance gain over traditional processor architectures. Unlike traditional processor architectures, which rely on copper-based electrical interconnects for intra-interposer communication, the processor architecture 100 uses optical interconnects for intra-interposer communication. Optical interconnects, generally, can handle much higher data transmission rates than electrical interconnects and do not suffer from high-frequency interference issues that are common in electrical interconnects. Therefore, by adapting to optical interconnects, the processor architecture 100 enables a high-speed computing system to handle much higher data throughput than high-speed computing systems with traditional processor architectures.

FIG. 2 illustrates an example first optical communication link 200 in accordance with various embodiments of the present disclosure. Each optical communication links of the plurality of first optical communication links 106a-106f of FIG. 1 can be represented by the first optical communication link 200. As discussed with reference to FIG. 1 above, the first optical communication link 200 can allow processors 210, 212 to communicate with each other to share computational tasks, for example. As shown in FIG. 2, in some embodiments, the first optical communication link 200 can comprise a plurality of first optical interconnects 202a-202b. Each optical interconnect of the plurality of first optical interconnects 202a-202b can be implemented using a waveguide, such as a photonic waveguide. For example, the first optical interconnect 202a can be a waveguide carrying data from the processor 210 to the processor 212 and the first optical interconnect 202b can be another waveguide carrying data from the processor 212 to the processor 210. In some embodiments, each end of the plurality of first optical interconnects 202a-202b can be coupled to a wavelength division multiplexer (WDM). For example, the first optical interconnect 202a can be coupled to a WDM 204aa at one end and coupled to a WDM 204ab at the other end. As another example, the first optical interconnect 202b can be coupled to a WDM 204ba at one end and coupled to a WDM 204bb at the other end.

In some embodiments, a WDM can be a transceiver device that can be configured either as a multiplexer or a demultiplexer. When a WDM is configured as a multiplexer, the WDM can convert and combine (i.e., multiplex or mux) multiple electrical signals into a single multiplexed optical signal, which carries multiple wavelengths, for data transmission through an optical interconnect. For example, in FIG. 2, the WDMs 204aa, 204ba are configured as multiplexers that multiplex electrical signals (e.g., “N Elec. Signals”) from their respective processors 210, 212 to multiplexed optical signals that can be transmitted through the first optical interconnects 202a, 202b, respectively. When a WDM is configured as a demultiplexer, the WDM can separate or decompose (e.g., demultiplex or demux) a multiplexed optical signal to its constituent electrical signals. For example, in FIG. 2, the WDMs 204ab, 204bb are configured as demultiplexers that demultiplex multiplexed optical signals transmitted through the first optical interconnects 202a, 202b, to their constituent electrical signals, which are then provided to the processors 210, 212, respectively. In this way, a number of interconnects needed for processor-to-processor communication can be reduced. For example, under traditional processor architecture, there can be 8 bidirectional data lanes (i.e., electrical interconnects) disposed between the processors 210, 212. In this example, the 8 bidirectional data lanes can be replaced with 2 unidirectional waveguides coupled to 4 WDMs with each WDMs capable of multiplexing 8 electrical signals carried by the 8 bidirectional data lanes into a single multiplexed optical signal and demultiplexing the single multiplexed optical signal back to the 8 electrical signals. Therefore, in this example, a number of interconnects can be reduced from 8 data lanes to 2 waveguides between the processors 210, 212, thereby significantly simplifying interconnect routing on an interposer (e.g., the interposer of FIG. 1) while still maintaining a same data transmission rate.

In some embodiments, a capability of a WDM to multiplex multiple electric signals into a single multiplexed optical signal depends on a laser source used in the WDM. For example, if a WDM has a laser source capable of outputting 8 different wavelengths of light, the WDM can multiplex 8 different electrical signals (e.g., channels) into a single multiplexed optical signal with each electrical signal modulated by a particular wavelength of light in the multiplexed optical signal. As another example, if a WDM unit has a laser source capable of outputting 16 different wavelengths of light, the WDM unit can multiplex 16 different electrical signals (e.g., channels) into a single multiplexed optical signal with each electrical signal modulated by a particular wavelength of light in the multiplexed optical signal. A WDM capable of multiplexing up to 18 channels of electrical signals is generally refer to as a coarse wavelength division multiplexer (CWDM). While a WDM capable of multiplexing up to 160 channels of electrical signals is generally refer to as a dense wavelength division multiplexer (DWDM). Now referring back to FIG. 2, in some embodiments, the WDMs 204ab, 204bb, 204ba, and 204bb can be implemented using CWDMs because these WDMs can multiplex at least 8 different channels of electrical signals into a single multiplexed optical signal and demultiplex the multiplexed optical signal back to the 8 different channels of electrical signals. In some embodiments, the WDMs 204ab, 204bb, 204ba, and 204bb can be implemented using DWDMs. In some embodiments, the WDMs 204ab, 204bb, 204ba, and 204bb can be implemented using some combination of CWDMs and DWDMs. Many variations are contemplated. In general, a decision to implement WDMs using CWDMs, DWDMs, or some combination of CWDMs and DWDMs may depend on a given processor architecture. For example, processors on an interposer may evolve to include an increasing number of electrical interconnects to increase data transmission between the processors and/or between the processors and memory components. In this example, in regards to multiplexing the electrical interconnects, DWDMs may be preferred over CWDMs because DWDMs can multiplex more electrical signals than CWDMs. In general, a decision to implement WDMs using CWDMs, DWDMs, or some combination of CWDMs and DWDMs depends on various factors. Such factors can include, for example, amount of spacing available on an interposer, component cost associated with CWDMs and DWDMs, component availability, and data rate or total bandwidth requirements between components (e.g., between processors or between processors and memory components).

FIG. 3 illustrates an example second optical communication link 300 in accordance with various embodiments of the present disclosure. Each optical communication links of the plurality of second optical communication links 108aa-108dd of FIG. 1 can be represented by the second optical communication link 300. As discussed with reference to FIG. 1 above, the second optical communication link 300 can allow a processor 310 to write data to and/or reading data from a memory component 312. As shown in FIG. 3, in some embodiments, the second optical communication link 300 can comprise a plurality of second optical interconnects 302a-302n. Each optical interconnect of the plurality of second optical interconnects 302a-302n can be implemented using a waveguide, such as a photonic waveguide. For example, the second optical interconnect 302a can be a waveguide carrying processor write data from the processor 310 to the memory component 312 and the second optical interconnect 302n can be another waveguide carrying processor read data from the memory component 312 to the processor 310. In some embodiments, each end of the plurality of second optical interconnects 302a-302n can be coupled to a wavelength division multiplexer (WDM). For example, the second optical interconnect 302a can be coupled to a WDM 304aa at one end and to a WDM 304ab at the other end. As another example, the second optical interconnect 302n can be coupled to a WDM 304na at one end and to a WDM 304nb at the other end.

In some embodiments, each of the WDMs 304aa-304nb may be coupled to a plurality of serializer-deserializers (SerDes) at either its inputs (“N Inputs”) or outputs (“N Outputs”). For example, in FIG. 3, inputs of the WDM 304aa are coupled to a plurality of SerDes 306aaa-306aan and inputs of the WDM 304na are coupled to a plurality of SerDes 306naa-306nan. As another example, in FIG. 3, outputs of the WDM 304ab are coupled to a plurality of SerDes 306aba-306abn and outputs of the WDM 304nb are coupled to a plurality of SerDes 306nba-306nbn.

In some embodiments, a SerDes can be a transceiver device that can be configured either as a serializer or a deserializer. When a SerDes is configured as a serializer, the SerDes can combine (e.g., serialize) multiple parallel electrical signals to a single serialized electrical signal for data transmission. For example, in FIG. 3, the plurality of SerDes 306aaa-306aan and the plurality of SerDes 306naa-306nan are configured as serializers that serialize parallel electrical inputs (e.g., “M Elec. Signals”) into serialized electrical signals that can be multiplexed by the WDM 304aa and the WDM 304na, for data transmission through the second optical interconnects 302a, 302n, respectively. When a SerDes is configured as a deserializer, the SerDes can separate (e.g., deserialize) a serialized electrical signal back to its constituent parallel electrical signals. For example, in FIG. 3, the plurality of SerDes 306aba-306abn and the plurality of SerDes 306nba-306nbn are configured as deserializers that deserialize serialized electrical signals demultiplexed by the WDM 304ab and the WDM 304nb, respectively, to their constituent parallel electrical signals (e.g., “M Elec. Signals”). In some embodiments, a capability of a SerDes to serialize or deserialize parallel electrical signals can be indicated by a SerDes ratio. For example, in FIG. 3, the plurality of SerDes 306aaa-306nbn can have a SerDes ratio of 8 because these SerDes can serialize 8 parallel electrical signals into a serialized electrical signal or deserialize a serialized electrical signal into 8 parallel electrical signals. As another example, a SerDes with a SerDes ratio of 4 can serialize 4 parallel electrical signals into a serialized electrical signal or deserialize a serialized electrical signal into 4 parallel electrical signals. In some embodiments, a SerDes ratio of a SerDes is user configurable. For example, a user can configure a SerDes to have a SerDes ratio of 4 or 8.

As discussed with reference to FIG. 2 above, a WDM can be a transceiver device that can either multiplex multiple electrical signals into a single multiplexed optical signal or demultiplex a single multiplexed optical signal to its constituent electrical signals. Also discussed with reference to FIG. 2 above, utilizing WDMs for intra-interposer communication may significantly reduce a number of interconnects needed for the intra-interposer communication. For example, assume that in FIG. 3, each of the WDMs 304aa-304na is a DWDM capable of multiplexing at least 16 different electrical signals (e.g., “N Inputs”) into a single multiplexed optical signal or demultiplexing a single multiplexed optical signal into 16 different electrical signals (e.g., “N Outputs”). Further, assume that there are 1024 bidirectional data lanes between the processor 310 and the memory component 312. By implementing the second communication link 300 with DWDMs, a number of interconnects from the processor 310 to the memory component 312 can be reduced from 1024 to 128 unidirectional interconnects (e.g., (1024/16)*2). These 128 unidirectional interconnects (e.g., waveguides) can be further reduced by utilizing SerDes. For example, as shown in FIG. 3, if the plurality of SerDes 306aaa-306nbn with a SerDes ratio of 8 is utilized in conjunction with the DWDMs, the 128 unidirectional interconnects can be further reduced to 16 unidirectional interconnects (e.g., (1024/16/8)*2). In this way, a number of interconnects between the processor 310 and the memory component 312 can be reduced from 1024 data lanes to just 16 waveguides, thereby significantly simplifying interconnect routing on an interposer (e.g., the interposer of FIG. 1) while still maintaining same data transmission rate.

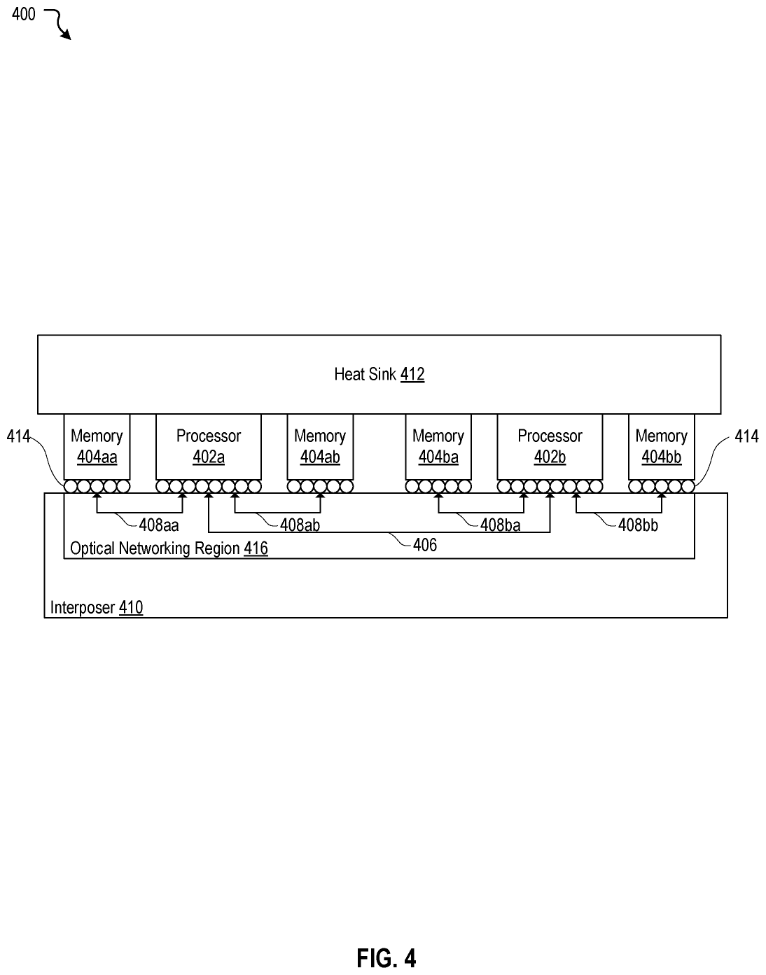

FIG. 4 illustrates a cross-sectional view 400 of an example interposer 410 in accordance with various embodiments of the present disclosure. In some embodiments, the interposer 110 of FIG. 1 can be implemented as the interposer 410. As shown in FIG. 4, the interposer 410 can comprise processors 402a, 402b, memory components 404aa-404bb, and a heat sink 412 thermally coupled to the processors 402a, 402b and the memory components 404aa-404bb. In some embodiments, the heat sink 412 can be a heat fin configured to maximize surface area to which heat generated by the processors 402a, 402b and the memory components 404aa-404bb can be dissipated through conduction and/or convection. In some cases, the heat sink 412 may be a thermal paste (e.g., thermal compound). In some embodiments, the processor 402a and the process 402b can be communicatively coupled to each other via a first optical communication link 406 (e.g., the first communication link 200 of FIG. 2). The memory components 404aa, 404ab can be communicatively coupled to the processor 402a via second optical communication links 408aa and 408ab (e.g., the second communication link 300 of FIG. 3), respectively. The memory components 404ba, 404bb can be communicatively coupled to the processor 402b via second optical communication links 408ba and 408bb (e.g., the second communication link 300 of FIG. 3), respectively. As shown in FIG. 4, in some embodiments, the processors 402a, 402b and the memory components 404aa-404bb can be disposed on the interposer 410 through a plurality of conductive balls 414 (e.g., solder balls or solder points) through which the processors 402a, 402b and the memory components 404aa-404bb can communicate with each other through the first communication link 406 and the second communication links 408aa-408dd.

In some embodiments, the interposer 410 can include an optical networking region 416, or optical network on chip (ONoC). The optical networking region 416 can include various optical and/or photonic devices associated with the first optical communication link 406 and the second optical communication links 408aa-408bb. For example, the optical networking region 416 can include CWDMs and waveguides associated with the first optical communication link 406. As another example, the optical networking region 416 can include DWDMs, SerDes, and waveguides associated with the second optical communication links 408aa-408bb. In some cases, the optical networking region 416 can further include various electrical front-end circuits, such as modulator drivers and transimpedance amplifiers (TIAs), associated with the various optical and/or photonic devices. For example, the optical networking region 416 can include driver and receiver circuitry as well as passive components such as resistors, capacitors, and/or inductors needed to condition various electrical signals associated with the processors 402a, 402b and the memory components 404aa-404bb. By having a dedicated region within the interposer 410 to incorporate various optical and/or photonic devices and front-end circuits to interface with the processors 402a, 402b and the memory components 404aa-404bb, the processors 402a, 402b and the memory components 404aa-404bb do not need modifications to add optical interconnect functionalities. Instead, existing processors and memory components may be used without any further modifications. In some embodiments, the interposer 410 with the optical networking region 416 can be implemented using an integrated silicon photonics (SiPh) interposer.

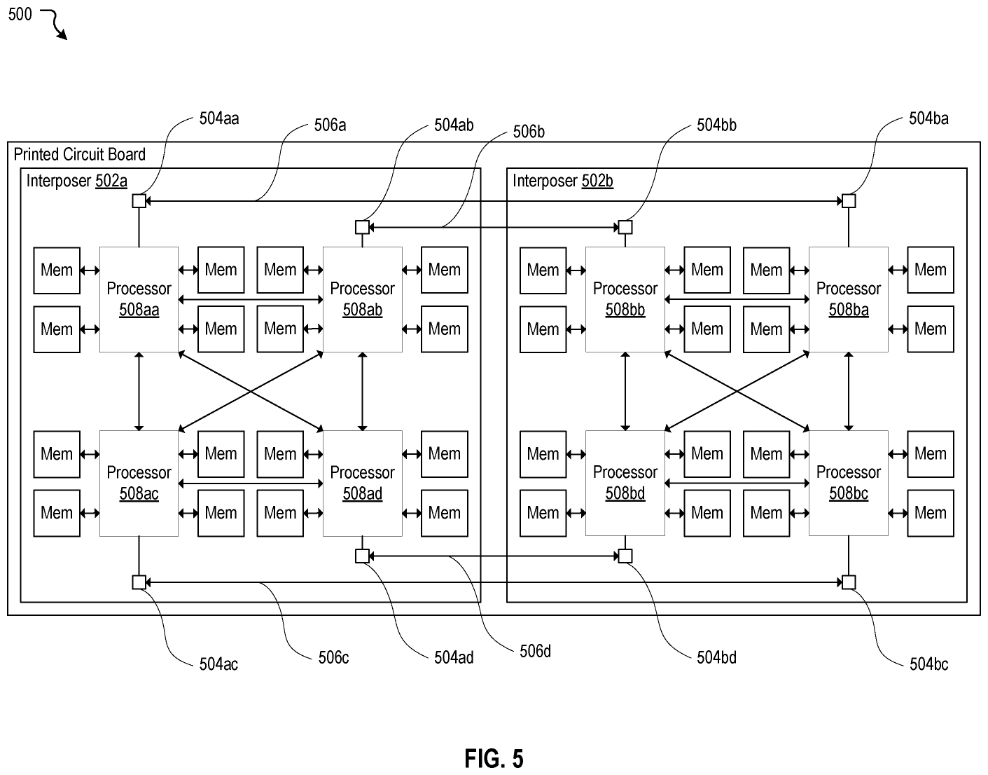

FIG. 5 illustrates an example printed circuit board (PCB) 500 of a high-speed computing system in accordance with various embodiments of the present disclosure. As shown in FIG. 5, the printed circuit board 500 can comprise an interposer 502a and an interposer 502b. In some embodiments, the interposer 110 of FIG. 1 can be implemented as the interposer 502a and the interposer 502b on the PCB 500. In some embodiments, the interposers 502a, 502b can include optical couplers 504aa-504bd that allow processors 508aa-508bd disposed on the interposers 502a, 502b to communicate with each other via fiber optic cables 506a-506d. For example, the processor 508aa disposed on the interposer 502a can be communicatively coupled to the processor 508ba disposed on the interposer 502b via the fiber optic cable 506a through the optical couplers 504aa, 504ba. As another example, the processor 508ad disposed on the interposer 502a can be communicatively coupled to the processor 508bd disposed on the interposer 502b via the fiber optic cable 506d through the optical couplers 504ad, 504bd. Because, inter-interposer communication are based on optical interconnects instead of electrical interconnects, the interposer 502a and the interposer 502b can be communicatively coupled via the fiber optic cables 506a-506d through the optical couplers 504aa-504bd, thereby allowing for inter-interposer communication. Such processor architectures allow the high-speed computing system to scale easily as computational demands increase. For example, computing capability of a computing system can be doubled by replacing an existing PCB with one interposer with the PCB 500 with two interconnected interposers 502a, 502b.

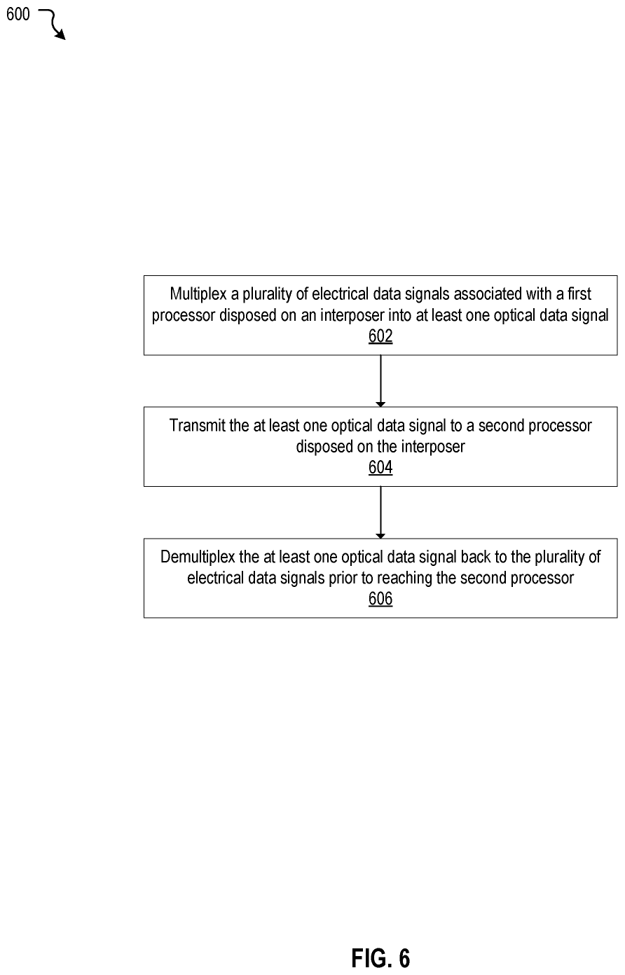

FIG. 6 illustrates an example method 600, according to various embodiments of the present disclosure. It should be appreciated that there can be additional, fewer, or alternative steps performed in similar or alternative orders, or in parallel, within the scope of the various embodiments discussed herein unless otherwise stated.

At block 602, the example method 600 can multiplex a plurality of electrical data signals associated with a first processor disposed on an interposer into at least one optical data signal. At block 604, the example method 600 can transmit the at least one optical data signal to a second processor disposed on the interposer. At block 606, the example method 600 can demultiplex the at least one optical data signal back to the plurality of electrical data signals prior to reaching the second processor. It is contemplated that there can be many other uses, applications, and/or variations associated with the various embodiments of the present technology.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

1. An optical network on chip (ONoC), the ONoC comprising:
a first optical communication link between a first processor and a second processor, the first optical communication link comprising:
a plurality of first wavelength division multiplexers (WDMs) coupled to the first processor and a plurality of second WDMs coupled to the second processor, wherein the first WDMs are configured to convert multiple electrical signals into a single optical signal and the second WDMs are configured to decompose the single optical signal into the multiple electrical signals; and
a plurality of first optical interconnects directly coupled between respective outputs of the plurality of first WDMs and respective inputs of the plurality of second WDMs; and
a second optical communication link between the first processor and a memory component, the second optical communication link comprising:
a plurality of first serializer-deserializers (SerDes) coupled to the first processor and a plurality of second SerDes coupled to the memory component;
a plurality of third WDMs coupled to the plurality of first SerDes and a plurality of fourth WDMs coupled to the plurality of second SerDes, wherein the third WDMs are configured to convert the multiple electrical signals into the single optical signal and the fourth WDMs are configured to decompose the single optical signal into the multiple electrical signals; and
a plurality of second optical interconnects directly coupled between respective outputs of the plurality of third WDMs and respective inputs of the plurality of fourth WDMs.

2. The ONoC of claim 1, wherein the plurality of first WDMs and the plurality of second WDMs are coarse wavelength division multiplexers (CWDMs).

3. The ONoC of claim 2, wherein the plurality of third WDMs and the plurality of fourth WDMs are dense wavelength division multiplexers (DWDMs).

4. The ONoC of claim 2, wherein:
some of the CWDMs are configured to multiplex one or more electrical data signals associated with either the first processor or the second processor into a multiplexed optical data signal; and
an optical interconnect of the plurality of first optical interconnects transmits the multiplexed optical data signal.

5. The ONoC of claim 2, wherein some of the CWDMs are configured to demultiplex a multiplexed optical data signal received through an optical interconnect of the plurality of first optical interconnects to one or more electrical data signals to be provided to either the first processor or the second processor.

6. The ONoC of claim 1, wherein the plurality of third WDMs and the plurality of fourth WDMs are dense wavelength division multiplexers (DWDMs).

7. The ONoC of claim 6, wherein the plurality of first WDMs and the plurality of second WDMs are coarse wavelength division multiplexers (CWDMs).

8. The ONoC of claim 6, wherein some of the DWDMs are configured to multiplex one or more serialized electrical data signals associated with either the first processor or the memory component into a multiplexed optical data signal.

9. The ONoC of claim 6, wherein some of the DWDMs are configured demultiplex a multiplexed optical data signal to one or more serialized electrical data signals to be provided to either the plurality of first SerDes or the plurality of second SerDes.

10. The ONoC of claim 1, wherein each SerDes of the plurality of first SerDes and each SerDes of the plurality of second SerDes has a user configurable SerDes ratio.

11. The ONoC of claim 1, wherein at least one SerDes of the plurality of first SerDes is configured to serialize one or more electrical data signals associated with first processor to a serialized electrical data signal and at least one SerDes of the plurality of second SerDes is configured to serialize one or more electrical data signals associated with the memory component to a serialized electrical data signal.

12. The ONoC of claim 1, wherein at least one SerDes of the plurality of first SerDes is configured to deserialize a serialized electrical data signal to one or more electrical data signals to be provided to the processor and at least one SerDes of the plurality of second SerDes is configured to deserialize a serialized electrical data signal to one or more electrical data signals to be provided to the memory component.

13. The ONoC of claim 1, wherein the first processor and the second processors are graphics processing units and the memory component is a high-bandwidth memory.

14. The ONoC of claim 1, wherein the plurality of first optical interconnects and the plurality of second optical interconnects are waveguides.

15. The ONoC of claim 1, wherein the plurality of first optical interconnects carries multiplexed optical data signals between the first processor and the second processor.

16. The ONoC of claim 1, wherein the plurality of second optical interconnects carries serialized multiplexed optical data signals between the first processor and the memory component.

17. The ONoC of claim 1, wherein the first processor, the second processor, and the memory components are disposed on an interposer associated with the ONoC.

18. The ONoC of claim 1, further comprising:
a heat sink disposed over the first processor, the second processor, and the memory component.

19. A method of inter-interposer communication, the method comprising:
serializing, at a first SerDes, a plurality of electrical data signals associated with a first processor disposed on an interposer;
receiving, from an output of the first SerDes, at a first wavelength division multiplexer (WDM), the serialized plurality of electrical data signals;
multiplexing, at the first WDM, the serialized plurality of electrical data signals into a single optical data signal;
directly transmitting the single optical data signal to a second WDM through an optical interconnect, wherein the optical interconnect is directly coupled to an output of the first WDM and to an input of the second WDM;
demultiplexing, using the second WDM, the single optical signal to decompose the single optical signal into the plurality of the electrical data signals;
receiving, from an output of the second WDM, at a second SerDes, the plurality of the electrical data signals;
deserializing, at the second SerDes, the plurality of the electrical data signals; and
transmitting the plurality of the electrical data signals to a second processor disposed on the interposer.

20. The method of claim 19, wherein the at last one optical data signal is transmitted through the optical interconnect disposed on the interposer.
